(19) United States
(12) Patent Application Publication
(10) Pub. No.: US 2014/0374939 A1
(43) Pub. Date: Dec. 25, 2014

(54) MANUFACTURING METHOD OF LENS DEVICE

(71) Applicant: HWA MEEI OPTICAL CO., LTD., TAINAN CITY (TW)

(72) Inventor: CHIH MING CHEN, TAINAN CITY (TW)

(21) Appl. No.: 13/922,403

(22) Filed: Jun. 20, 2013

(51) Int. Cl. B29D 12/02; B29C 45/16

(52) U.S. Cl. CPC B29D 12/02; B29C 45/16
USPC 264/46.4; 264/255

(57) ABSTRACT

A manufacturing method of a lens device includes steps of: injecting an outer-layer material into a mold; injecting an inner-layer material into the mold, wherein the inner-layer material is enclosed by the outer-layer material; and solidifying the outer-layer material and the inner-layer material. The lens device made by the manufacturing method of this invention can exert the advantage of decreasing the cost.

### BACKGROUND OF THE INVENTION

1. Field of the Invention

The invention relates to a manufacturing method of a lens device.

2. Description of the Prior Art

The lens device, such as sunglasses, working goggles, nearsighted eyeglasses, farsighted spectacles, presbyopia eyeglasses or the like, have become an indispensable appliance, helping people's living a lot. However, there are still some inconveniences in usage although the eyeglasses industry has been developed to this day. For example, the conventional eyeglasses are too heavy, so that the user getting used to wear eyeglasses will have sunken wings of the nose, which also affects the user's appearance. Besides, it's also an important issue how the manufacturing method of the lens device is in cooperation with the environmental protection. Furthermore, how to reduce the cost and enhance the usability of the lens device is also important.

Moreover, in the prior art, two molds are necessarily required to be used for manufacturing a dual layer lens device. One mold is for forming the inner-layer structure, and the other is for forming the outer-layer structure enclosing the inner-layer structure. However, because two molds are required, the process steps and the cost will be increased.

Therefore, it is an important subject to provide a manufacturing method of a lens device that can reduce the cost, and can make a lighter lens device, or achieve the environmental protection, or enhance the usability.

### SUMMARY OF THE INVENTION

In view of the foregoing subject, an objective of the invention is to provide a manufacturing method of lens device that can reduce the cost, and can make a lighter lens device, or achieve the environmental protection, or enhance the usability.

To achieve the above objective, a manufacturing method of a lens device comprises steps of: injecting an outer-layer material into a mold; injecting an inner-layer material into the mold, wherein the inner-layer material is enclosed by the outer-layer material; and solidifying the outer-layer material and the inner-layer material.

In one embodiment, the outer-layer and inner-layer materials are at least injected into the portion of the mold corresponding to a frame of the lens device.

In one embodiment, the outer-layer and inner-layer materials are at least injected into the portion of the mold corresponding to a temple of the lens device.

In one embodiment, the step of injecting the outer-layer material is before the step of injecting the inner-layer material. Besides the step of injecting the inner-layer material can be implemented according to the state of the outer-layer material in the mold.

In one embodiment, the inner-layer material and the outer-layer material are the same or different.

In one embodiment, the inner-layer material and the outer-layer material have the same or different color or transparency.

In one embodiment, the inner-layer material and the outer-layer material have the same or different rigidity.

In one embodiment, the density of at least one of the inner-layer material and outer-layer material is less than 1

In one embodiment, at least one of the inner-layer material and outer-layer material is a recycled material.

In one embodiment, at least one of the inner-layer material and outer-layer material is a foaming material.

As mentioned above, in the manufacturing method of the invention, a single mold is just required to manufacture a dual layer lens device, and therefore the cost can be reduced and the process can be simplified. Besides, at least a portion of the lens device made by the manufacturing method of the invention has an inner layer and an outer layer, and the outer layer encloses the inner layer. In one embodiment, at least one of the inner-layer and outer-layer materials can be a recycled material, and therefore the environmental protection can be achieved and the cost can be decreased. In one embodiment, at least one of the inner-layer and outer-layer materials can be a lighter material so that the total weight of the lens device can be decreased, and therefore the pressure on the wings of the user's nose is lightened. Besides, the product usability and competitiveness is enhanced thereby. In one embodiment, the density of at least one of the inner-layer material and outer-layer material can be less than 1, i.e. the density of water. Therefore, when the user doing aquatic sports loses the eyeglasses, the user can easily find them. In one embodiment, at least one of the inner-layer material and outer-layer material can be a foaming material, and thereby the bubbles can be generated in at least one of the inner layer and outer layer for decreasing the total weight. In one embodiment, the inner-layer material and the outer-layer material can have different color or transparency, and the visual effect can be varied thereby. In one embodiment, the inner-layer material and the outer-layer material can have different rigidity, and different touch feeling and structural strength can be provided thereby. Accordingly, the invention can manufacture a lighter lens device, or achieve the environmental protection, or enhance the usability.

### BRIEF DESCRIPTION OF THE DRAWINGS

FIG. 1 is a flow chart of a manufacturing method of a lens device according to a preferred embodiment of the invention;

FIG. 2 is a schematic diagram of a lens device manufactured by the manufacturing method of the embodiment of the invention;

FIGS. 3a to 3c are schematic sectional diagrams of some variations of a portion of the lens device in FIG. 2;

FIG. 4 is a schematic diagram of another lens device manufactured by the manufacturing method of the embodiment of the invention; and

FIGS. 5a to 5c are schematic sectional diagrams of some variations of a portion of the lens device in FIG. 4.

### DETAILED DESCRIPTION OF THE INVENTION

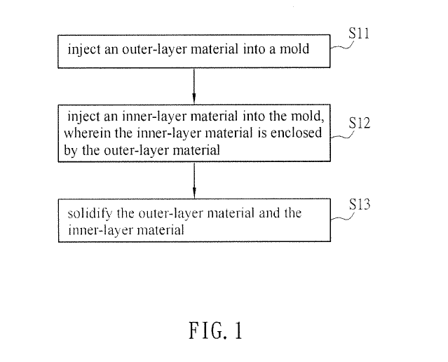

FIG. 1 is a flow chart of a manufacturing method of a lens device according to a preferred embodiment of the invention, including the steps S11 to S13. In the invention, the lens device made by the manufacturing method of the invention is not limited in structure, shape or type, which can be a pair of sunglasses, working goggles, nearsighted eyeglasses, farsighted spectacles, presbyopia eyeglasses, snow goggles, or the like.

The step S11 is to inject an outer-layer material into a mold. The outer-layer material is used to form at least a portion of the outer layer of the lens device. The outer-layer material is a plastic material for example.

The step S12 is to inject an inner-layer material into the mold, wherein the inner-layer material is enclosed by the outer-layer material. The inner-layer material is used to form at least a portion of the inner layer of the lens device, and the outer layer encloses the inner layer. The inner-layer material is a plastic material for example. In an embodiment, the outer-layer and inner-layer materials are at least injected into the portion of the mold corresponding to a frame of the lens device. In an embodiment, the outer-layer and inner-layer materials are at least injected into the portion of the mold corresponding to a temple of the lens device. In an embodiment, the outer-layer and inner-layer materials are at least injected into the portions of the mold corresponding to a frame and temple of the lens device.

As an embodiment, the step of injecting the outer-layer material (S11) is before the step of injecting the inner-layer material (S12). In this case, the step of injecting the inner-layer material can be implemented according to the state of the outer-layer material in the mold, and this is more effective when the outer-layer and inner-layer materials are the same. When the outer-layer material in the mold is slightly solidified, the inner-layer material can be injected, and thus the outer-layer and inner-layer materials can be prevented from being mixed together. Thereby, the dual layer structure including the outer layer and inner layer can be made.

The inner-layer material and the outer-layer material can be the same or different. The inner-layer material and the outer-layer material can have the same or different color or transparency, and the visual effect can be enhanced thereby. The inner-layer material and the outer-layer material can have the same or different rigidity, and different touch feeling and structural strength can be provided thereby. The density of at least one of the inner-layer material and outer-layer material can be less than 1, so that the density of the lens device is less than 1 for enhancing the usability. At least one of the inner-layer material and outer-layer material can be a recycled material, and the environmental protection can be achieved and the cost can be decreased thereby. At least one of the inner-layer material and outer-layer material can be a foaming material, and the bubbles can be generated in at least one of the inner layer and outer layer thereby for decreasing the total weight.

In one embodiment, the outer-layer material is, for example but not limited to, PA66, PA12, PC, thermoplastic polyurethane (TPU) or thermoplastic rubber (TPR). The inner-layer material is, for example but not limited to, polypropylene (PP), TPX, TPU, PP66, phenylpropanolamine (PPA12), PC or TPR.

The step S13 is to solidify the outer-layer material and the inner-layer material, and the partial or complete lens device can be made thereby. Herein, the outer-layer and inner-layer materials can start to be solidified at the same time or different times. The time required for the individual solidification of the outer-layer and inner-layer materials can be the same or different. The solidification can be achieved by a natural way or by applying an external force (thermal, pressure, etc.). In this embodiment, the outer-layer and inner-layer materials are solidified by an injection molding.

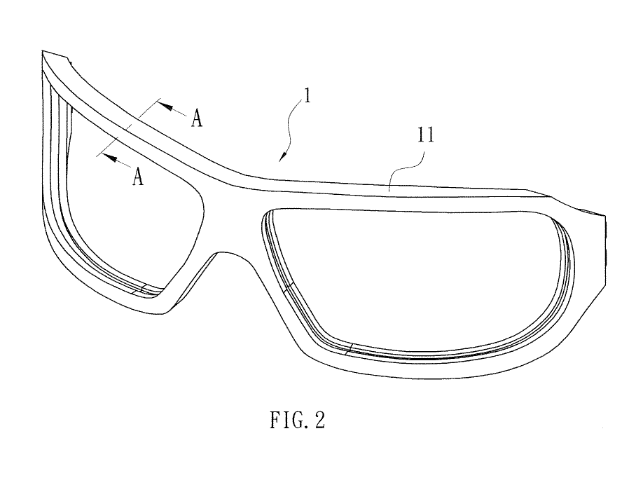

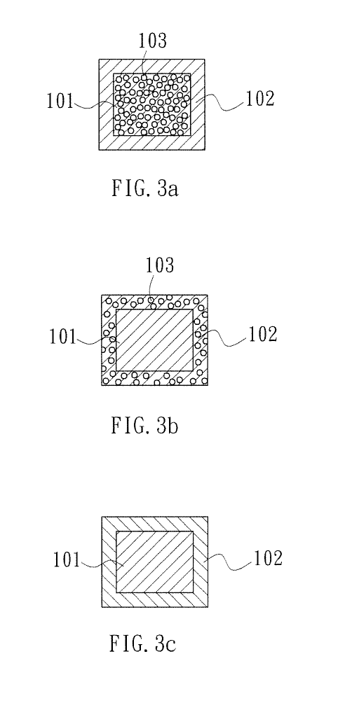

FIG. 2 is a schematic diagram of a lens device 1 manufactured by the manufacturing method of the embodiment of the invention. Here only a frame 11 of the lens device 1 is shown, but the lens device 1 can further include other structure, such as a temple. FIGS. 3a to 3c are schematic sectional diagrams of some variations of a portion of the lens device 1 in FIG. 2. As shown in FIGS. 2 and 3a to 3c, at least a portion of the lens device 1 has an inner layer 101 and an outer layer 102, and the outer layer 102 encloses the inner layer 101. As shown in FIG. 3a, the inner layer 101 has bubbles 103 therein and the outer layer 102 has no bubble. As shown in FIG. 3b, the outer layer 102 has bubbles 103 therein and the inner 101 has no bubble. As shown in FIG. 3c, the outer layer 102 and the inner layer 101 both have no bubble.

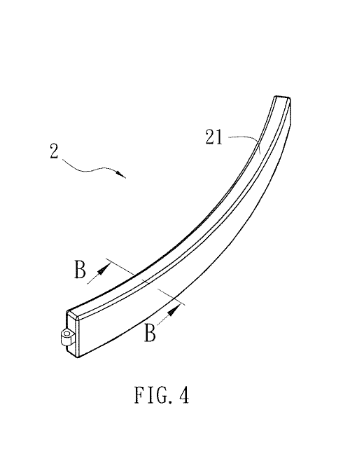

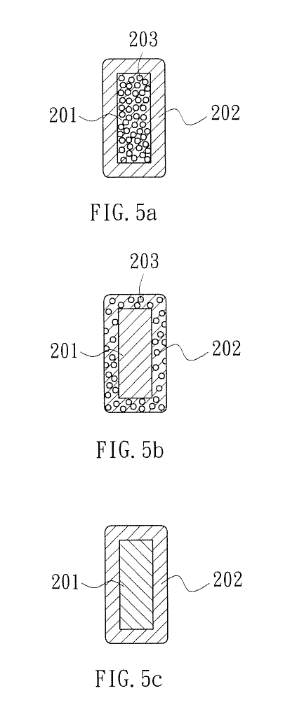

FIG. 4 is a schematic diagram of another lens device 2 manufactured by the manufacturing method of the embodiment of the invention. Here only a temple 21 of the lens device 2 is shown, but the lens device 2 can further include other structure, such as a frame. FIGS. 5a to 5c are schematic sectional diagrams of some variations of a portion of the lens device 2 in FIG. 4. As shown in FIGS. 4 and 5a to 5c, at least a portion of the lens device 2 has an inner layer 201 and an outer layer 202, and the outer layer 202 encloses the inner layer 201. As shown in FIG. 5a, the inner layer 201 has bubbles 203 therein and the outer layer 202 has no bubble. As shown in FIG. 5b, the outer layer 202 has bubbles 203 therein and the inner 201 has no bubble. As shown in FIG. 5c, the outer layer 202 and the inner layer 201 both have no bubble.

In summary, in the manufacturing method of the invention, a single mold is just required to manufacture a dual layer lens device, and therefore the cost can be reduced and the process can be simplified. Besides, at least a portion of the lens device made by the manufacturing method of the invention has an inner layer and an outer layer, and the outer layer encloses the inner layer. In one embodiment, at least one of the inner-layer and outer-layer materials can be a recycled material, and therefore the environmental protection can be achieved and the cost can be decreased. In one embodiment, at least one of the inner-layer and outer-layer materials can be a lighter material so that the total weight of the lens device can be decreased, and therefore the pressure on the wings of the user's nose is lightened. Besides, the product usability and competitiveness is enhanced thereby. In one embodiment, the density of at least one of the inner-layer material and outer-layer material can be less than 1, i.e. the density of water. Therefore, when the user doing aquatic sports loses the eyeglasses, the user can easily find them. In one embodiment, at least one of the inner-layer material and outer-layer material can be a foaming material, and thereby the bubbles can be generated in at least one of the inner layer and outer layer for decreasing the total weight. In one embodiment, the inner-layer material and the outer-layer material can have different color or transparency, and the visual effect can be varied thereby. In one embodiment, the inner-layer material and the outer-layer material can have different rigidity, and different touch feeling and structural strength can be provided thereby. Accordingly, the invention can manufacture a lighter lens device, or achieve the environmental protection, or enhance the usability.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A manufacturing method of a lens device, comprising steps of:
injecting an outer-layer material into a mold;
injecting an inner-layer material into the mold, wherein the inner-layer material is enclosed by the outer-layer material; and
solidifying the outer-layer material and the inner-layer material.

2. The manufacturing method as recited in claim 1, wherein the outer-layer and inner-layer materials are at least injected into the portion of the mold corresponding to a frame of the lens device.

3. The manufacturing method as recited in claim 1, wherein the outer-layer and inner-layer materials are at least injected into the portion of the mold corresponding to a temple of the lens device.

4. The manufacturing method as recited in claim 1, wherein the step of injecting the outer-layer material is before the step of injecting the inner-layer material.

5. The manufacturing method as recited in claim 4, wherein the step of injecting the inner-layer material is implemented according to the state of the outer-layer material in the mold.

6. The manufacturing method as recited in claim 1, wherein the inner-layer material and the outer-layer material are the same or different.

7. The manufacturing method as recited in claim 1, wherein the inner-layer material and the outer-layer material have the same or different color or transparency.

8. The manufacturing method as recited in claim 1, wherein the inner-layer material and the outer-layer material have the same or different rigidity.

9. The manufacturing method as recited in claim 1, wherein the density of at least one of the inner-layer material and outer-layer material is less than 1

10. The manufacturing method as recited in claim 1, wherein at least one of the inner-layer material and outer-layer material is a recycled material.

11. The manufacturing method as recited in claim 1, wherein at least one of the inner-layer material and outer-layer material is a foaming material.
